(19) United States
(12) Patent Application Publication
(10) Pub. No.: US 2014/0282421 A1
(43) Pub. Date: Sep. 18, 2014

(54) DISTRIBUTED SOFTWARE VALIDATION

(71) Applicant: MICROSOFT CORPORATION, Redmond, WA (US)

(72) Inventors: Marwan E. Jubran, Redmond, WA (US); Aleksandr Gershaft, Redmond, WA (US); Vladimir Petrenko, Redmond, WA (US); Igor Avramovic, Seattle, WA (US); Weiping Hu, Seattle, WA (US); Paul Chiang, Bellevue, WA (US)

(73) Assignee: MICROSOFT CORPORATION, Redmond, WA (US)

(21) Appl. No.: 13/841,027

(22) Filed: Mar. 15, 2013

(51) Int. Cl. G06F 11/36

(52) U.S. Cl. CPC G06F 11/3672
USPC 717/126

(57) ABSTRACT

A computer-implemented method for validation of a software product via a distributed computing infrastructure includes receiving configuration data for a plurality of validation tasks of the validation, receiving code data representative of the software product, defining a validation pipeline to implement the plurality of validation tasks based on the configuration data, and initiating execution of the plurality of validation tasks on a plurality of virtual machines of the distributed computing infrastructure. Initiating the execution includes sending the code data and data indicative of the defined validation pipeline to configure each virtual machine in accordance with the code data and the defined validation pipeline.

### BACKGROUND OF THE DISCLOSURE

### Brief Description of Related Technology

Computers accomplish tasks by processing sets of instructions derived from software source code. Software source code is typically written by a software developer using one or more programming languages. Most programming languages have a software source code compiler to compile the source code into one or more computer readable data files. A software application often involves a package of such data files.

Some software development projects may involve thousands, or even hundreds of thousands, of source code files having a complex dependency structure. A change in one source code file may thus cause undesirable conditions or unexpected results and failures for a large number of other source code files. Because of the complexities arising from such interactions between the source code files, software applications are commonly developed in test-driven development processes.

A test-driven development process involves testing the software application throughout development to ensure that the application functions as intended. For example, an automated test case, or unit test, is written in connection with the definition of a new function of the software application. Unit testing provides a technique for observing the functionality of specific components or sections of code, but often results in thousands of tests for a given software application.

### SUMMARY OF THE DISCLOSURE

Methods, systems, and computer program products are directed to implementing software validation with a distributed computing architecture. A validation pipeline is defined for a number of validation tasks to be executed by a number of virtual machines of the distributed computing architecture.

In accordance with one aspect of the disclosure, a validation pipeline is defined for a plurality of validation tasks based on configuration data for a software validation. Execution of the validation tasks is initiated via a plurality of virtual machines of a distributed computing architecture configured in accordance with the defined validation pipeline.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWING FIGURES

For a more complete understanding of the disclosure, reference is made to the following detailed description and accompanying drawing figures, in which like reference numerals may be used to identify like elements in the figures.

FIG. 1 is a block diagram of an exemplary system configured for distributed software validation in accordance with one embodiment.

FIG. 2 is a block diagram of a validation client of the system of FIG. 1 in accordance with one embodiment.

FIGS. 3 and 4 are flow diagrams of an exemplary computer-implemented method for distributed software validation in accordance with one embodiment.

FIG. 5 is a block diagram of a computing environment in accordance with one embodiment for implementation of the disclosed methods and systems or one or more components or aspects thereof.

While the disclosed systems and methods are susceptible of embodiments in various forms, specific embodiments are illustrated in the drawing (and are hereafter described), with the understanding that the disclosure is intended to be illustrative, and is not intended to limit the invention to the specific embodiments described and illustrated herein.

### DETAILED DESCRIPTION

Methods, systems, and computer program products are described for validation of a software product via a distributed computing architecture, such as a cloud architecture. Configuration data is used to define a validation pipeline for a plurality of validation tasks to be implemented. Virtual machines of the distributed computing architecture are configured in accordance with the validation pipeline definition to implement various tests, analyses, and/or other validation tools. The validation pipeline definition may thus direct the deployment of the validation tasks across the distributed computing architecture. The configuration data may be used to customize the validation pipeline and/or the validation tasks thereof for a specific software product or component thereof.

The definition of the validation pipeline may facilitate the distribution of the validation tasks across the distributed computing architecture. The validation tasks may be implemented in parallel. The validation processing capacity of the disclosed embodiments may be scaled to support the implementation of a large number of validation tasks. The disclosed embodiments may thus be useful in testing large code bases and/or in implementing a large number of tests. For instance, the parallel and scalable processing of the disclosed embodiments may be useful in connection with unit testing frameworks, which, may contain thousands of tests. By scaling to match the load of a validation process, the disclosed embodiments may provide timely and useful feedback on the quality of the software product under development despite the complexity of the test suite.

The disclosed embodiments may be implemented via a cloud-based service designed to provide quick verification and deliver relevant and intuitive feedback for code changes. Given a software change (e.g., a change list or a build), the disclosed embodiments facilitate the execution of various validation tasks (e.g. unit test, integration test, code analysis, etc.) and the aggregation and presentation of the results of the tasks. The results and other artifacts of the validation may be stored in a cloud-based or other distributed or networked data store, which may support increased availability and resiliency. Software developers may use the disclosed embodiments to validate a number of components or large-scale system changes, and implement a wide variety of validation tasks (e.g., one-box testing), while maintaining an agile development cycle.

The disclosed embodiments may be configured to support multiple validation processes. For example, any number of development teams may utilize the cloud-based service concurrently to leverage the distributed computing infrastructure. The disclosed embodiments may isolate the validation processes of the different teams so that stresses realized by the load presented by one team do not adversely affect the validation process of other teams. The scalability of the distributed computing infrastructure may help avoid other resource contention issues.

The parallelization of the validation process provided by the disclosed embodiments may be employed to improve the efficiency of the validation process. The disclosed embodiments may automate the parallelization and other management of the validation. Such automation may enable software developers to validate software products more quickly and more frequently. For example, with the disclosed embodiments, a developer need not wait several days for the results of the validation. With the results of the validation arriving more quickly, a continuous validation experience may be provided.

Notwithstanding references herein to various validation tools supported via the disclosed embodiments, the disclosed embodiments are not limited to any particular type of validation task or tool. The disclosed embodiments may support a wide variety of analysis tools, test tools, and other validation tools. The validation provided by the disclosed embodiments is not limited to a particular software test or analysis framework. The tools used in a particular validation process may thus be provided by multiple sources. The validation tools may be loosely coupled via the distributed computing infrastructure of the disclosed embodiments (e.g., via a global namespace). For example, the disclosed embodiments may be configured to provide the input parameters used by the various validation tools, as well as collect output data generated thereby for presentation via a user interface.

Although described in connection with cloud-based services, the disclosed embodiments are not limited to any specific operating system, environment, platform, or computing infrastructure. The nature of the software products processed via the disclosed embodiments may vary. For example, a software product need not involve a full or complete software application, such as an integrated software build released to production. Instead, the software product may involve a branch or other component of a software application or system. The disclosed embodiments may be used to validate various types of software products, which are not limited to any particular operating system, operating or computing environment or platform, or source code language.

FIG. 1 depicts an architecture 100 in which one or more software products under development are validated. The architecture 100 may be configured as a distributed system of components or subsystems configured for validation of the software product(s). For example, the architecture 100 may be include computers or computing systems configured in a client-server arrangement. In this embodiment, the architecture 100 includes a validation client 102 in networked communication with a validation server 104. The networked communication may include data exchanges over an internet connection 106 and/or any other network connection. The validation client 102 may be configured to access, utilize, and/or control one or more services of the validation server 104 to implement the validation of software products as described herein. In some embodiments, the validation client 102 is configured as a controller or control unit of the validation process for a particular development team or developer.

The validation client 102 and the validation server 104 may include any computer or other computing system, examples of which are described below in connection with FIG. 5. The validation client 102 and the validation server 104 may include one or more data stores or memories in which instructions, code data, and other data are stored. In the embodiment of FIG. 1, the architecture 100 includes a data store 108 in which configuration data for a plurality of validation tasks of the validation is stored. The data store 108 may be integrated with the validation client 102 to any desired extent. For example, the validation client 102 and the data store 108 may be integrated as components of a local (e.g., on premise) computing system configured to utilize and direct the services provided by the validation server 104 and/or other remote or distributed components of the architecture 100. The data store 108 may include a file system and/or a database configured for access by the validation client 102, but other configurations, data structures, and arrangements may be used.

The validation client 102 may include, or be in communication with, other data stores or data sources to obtain code data, tool data, and other data for the validation. In the example of FIG. 1, the validation client 102 is coupled to a build system 110 and a code review system 112 to obtain code data representative of the software product to be processed. The configuration of the code data may vary. For example, the code data may include source code data and/or binary data (e.g., binaries). In some embodiments, the build system 110 may provide build and/or intermediate representation (IR) data (build/IR data 114), such as abstract syntax tree data, for one or more components of the software product. The code review system 112 may provide change list data 116 representative of recent changes to the source code of the software product. The change list data 116 may be used to determine the components of the software product to be tested, analyzed, or otherwise validated. The build/IR data 114 and/or the change list data 116 may be stored in the data store 108 or any other data store in communication with the validation client 102.

The build system 110 may be directed to compiling source code data into binary code, and packaging the binary code. The build system 110 may include a number of tools and repositories for processing and handling the source code and binary code files and data. For example, the build system 110 may include, configure, or access a file server in which the results of a build are stored. Any build software, tool, and/or infrastructure may be used in the build system 110. In one example, the build system 110 utilizes the MSBuild build platform (Microsoft Corporation), which may be available via or in conjunction with the Microsoft® Visual Studio® integrated development environment. Other build systems and/or integrated development environments may be used. For example, the build system 110 may be provided or supported via a cloud or other networked computing arrangement, such as cloud-based system described in U.S. Patent Publication No. 2013/0055253 (“Cloud-based Build Service”), the entire disclosure of which is hereby incorporated by reference.

In some cases, the validation client 102 may be integrated with one or more components of the build system 110. For example, one or more user interfaces of the validation client 102 may be integrated with the user interface(s) generated by the build system 110. In such cases, the build system 110 may provide code analysis, dependency analysis, and other analysis tools that may be available for application by the validation client 102. The implementation of the analysis tools may then be supported by the distributed resources of the architecture 100, rather than solely by the computer(s) running the build system 110.

The code review system 112 may be configured to detect changes in the source code files and generate change lists including data indicative of the detected changes. The source code files may correspond with versions of the source code that have yet to be committed to a source control system (e.g., checked into a source tree). The configuration, type, and other characteristics of the code review system 112 may vary. The validation client 102 may receive input data from the code review system 112 and/or other sources. The input data may include existing code (e.g., source code), code with changes applied, and/or a combination of code and a representation of changes thereto, such as a single file, a link to a remote file, a reference to a set of changes within a repository, or other changes that may or may not be applied to the current codebase.

The build system 110 and the code review system 112 may obtain source code from one or more source control services, one or more project management services, and/or other services. One or more of such services may be provided by a server (not shown) configured in accordance with the Team Foundation Server platform from Microsoft Corporation, which may be provided as part of a Visual Studio® system, such as the Visual Studio® Application Lifecycle Management system. The source code may be developed in connection with any type of source control system or framework. The source code may be written in any one or more languages.

The validation client 102 may also be in communication with a data store in which validation tool binary data 118 is stored. The validation tool binary data 118 may include instruction sets operable to execute various types of validation tools, including, for example, unit testing tools and code analysis tools, against the code of the software product. In some cases, the validation tool binary data 118 is representative of default or standard validation tools available for use in the validation process. A default configuration of the standard validation tools may be customized or otherwise modified in accordance with the configuration data in the data store 108, as described herein. Alternatively or additionally, the validation tool binary data 118 also includes parameter data to configure the operation of the validation tools. In some embodiments, the validation tool binary data 118 is stored in the data store 108.

The validation tools are configured to validate the operability and other characteristics of the code data. Some validation tools may be directed to executing a number of tests configured to determine whether the binary code of a build works as intended. For example, one or more tests may be configured to determine whether the binary code meets a number of specifications for the software product. A variety of different types of testing may be supported, including, for instance, unit testing, functional testing, stress testing, fault injection, penetration testing, etc. Other validation tools may be directed to implementing static code analysis of the software product. For example, the static code analysis may be configured to implement dependency analysis, change impact analysis, pattern analysis, and other types of code analyses. Other types of validation tasks may be implemented by the validation tools. The disclosed embodiments are not limited to any particular testing or analysis framework.

The implementation of the validation tools is supported via communications between the validation client 102 and the validation server 104. The communications may include networked communications via an internet connection 106 or other network connection. The validation server 104 is configured to enable, manage, or otherwise support communications between the validation client 102 and other components of the architecture 100, such as the data store(s) and/or the distributed computing resources used to implement the validation tools. For example, the validation server 104 may include or present a service layer via one or more application programming interfaces (APIs) to support various types of communications, including, for example, to perform various requests from the validation client 102. The requests may include or relate to, for example, the initiation of a validation pipeline and data retrieval regarding pipeline status and/or system states. The service layer may be replicated and provided via any number of instances of the validation server 104.

In this embodiment, the validation client 102 uses a communication management service 120 of the validation server 104 to exchange data with the cloud-based and other components of the architecture 100. The communication management service 120 may be configured as a web front end or portal through which data from the validation client 102 may pass. For example, the communication management service 120 may receive a data package including code data and validation tool binary data 118 and redirect the data package to a desired destination, such as a cloud-based data store 122 or other distributed or networked data store. The data package may then be available for deployment within or across the architecture 100, as described herein. Alternatively or additionally, the validation client 102 may communicate with the cloud-based data store 122 without the communication management service 120 of the validation server 104 as an intermediary, or with a different intermediary.

The cloud-based data store 122 may include a Microsoft® SQL Server® or SQL Azure™ database management system from Microsoft Corporation, but other database management systems or data store architectures may be used. Non-database systems may also be used, including, for example, the Windows Azure™ storage service from Microsoft Corporation. Hosted services other than the Windows Azure™ hosted service may alternatively be used to support the cloud-based data store 122. In addition to the cloud-based data store 122, one or more other components of the architecture 100 may be provided via a cloud-based or other hosted service. For example, the validation server 104 may be provided via a hosted service, such as a Windows Azure™ hosted service. The hosted service may provide multiple instances of one or more roles of the validation server 104 to provide increased availability and/or resiliency of the validation server 104. Such increased availability may allow a large number of validation clients 102 to utilize the resources provided by the architecture 100.

In the embodiment of FIG. 1, the code data and the validation tool binary data 118 are stored in the cloud-based data store 122 after processing by the validation client 102. Such processing may include or involve the customization of one or more validation tools and/or packaging of the validation tool(s) with the code data for a job to be implemented in a validation pipeline, as described below. Each package of code data and validation tool data may be used to configure one of a plurality of virtual machines of the architecture 100, as described below. The data packages for the jobs may be sent to the cloud-based data store 122 via the communication management service 120 of the validation server 104.

The packaged data for each job may be stored in the cloud-based data store 122 as a binary large object (BLOB), although other data structures, storage frameworks, or storage arrangements may be used. The storage of the packaged data in the cloud-based data store 122 may thus support the scalability of the validation services provided by the disclosed embodiments. With a large or virtually limitless storage capacity, the cloud-based data store 122 may provide increased data availability and resiliency during operation. Other data may be stored in the cloud-based data store 122, such as data indicative of the results of the validation process.

The communication management service 120 of the validation server 104 may also facilitate networked communications (e.g., via an internet connection 106) with a deployment manager 124 of the architecture 100. For example, the validation client 102 may send instructions, requests, and other messages to the deployment manager 124 via the communication management service 120. The deployment manager 124 may be configured to provide a plurality of services for deploying the resources of a distributed computing infrastructure 126 to perform the jobs of the validation pipeline. The deployment manager 124 may also be configured to manage the resources of the distributed computing infrastructure 126. As a resource manager, the deployment manager 124 may be configured to manage the allocation (e.g., isolation), instantiation (e.g., imaging or re-imaging), operation, and other configuration of a plurality of virtual machines of the distributed computing infrastructure 126. The configuration of the virtual machines by the deployment manager 124 may include an initial configuration of a virtual machine in accordance with one of the data packages stored in the cloud-based data store 122, as well as include a data wiping or reimaging after completion of a job. The data wiping may return the virtual machine to an original state before the initial configuration. The data wiping may be used to prepare the virtual machine for use in deployment of another job in the pipeline (or another pipeline). Such reimaging logic may be based on a heuristic and/or a state of the job outcome. The heuristic may be directed to job output, job type, job history (e.g., failure frequency, subsequent failure frequency), and/or virtual machine history (e.g., number of jobs run and/or execution time). The data wiping may be useful in situations in which a validation task (e.g., a test) has resulted in one or more failures or other actions that have changed the system state of the virtual machine, rendering further testing on the virtual machine subject to uncertainty. For example, without the data wiping, it may otherwise be difficult to determine whether a subsequent test failure was caused by the changed system state or a fault in the software product being tested.

In some embodiments, the deployment manager 124 may include a system for providing the resources of the distributed computing infrastructure 126 via a platform as a service to perform the jobs of the validation pipeline. The deployment manager 124 may provide automated management of job queues, including job scaling, job scheduling, job migration, and other resource allocation and management functions. Such functions may be useful in load balancing and failure responses. Further details regarding examples of the deployment manager 124 are set forth in U.S. patent application Ser. No. 13/346,416 (“Assignment of Resources in Virtual Machine Pools”), and Ser. No. 13/346,303 (“Decoupling PAAS Resources, Jobs, and Scheduling”), the entire disclosures of which are hereby incorporated by reference. Other methods and systems for allocating and managing the resources of the distributed computing infrastructure 126 may be used. For instance, some cloud services in addition to the services referenced above may provide automated resource scaling. In one example, the Windows Azure™ hosted services may provide automated scaling, further information for which is available at http://blogs.msdn.com/b/gonzalorc/archive/2010/02/07/auto-scaling-in-azure.aspx.

The distributed computing infrastructure 126 may include one or more networks 128 to which the virtual machines are logically or otherwise connected. The network 128 and the physical machines on which the virtual machines are running may be arranged in a data center. In the example of FIG. 1, the deployment manager 124 is co-located with the network 128. In other cases, the deployment manager 124 may be in communication with the data center(s), the network(s) 128, and the virtual machines via an internet connection 106. The configuration of the distributed computing infrastructure 126 may vary. The virtual machines may be distributed across any number of data centers and run on physical machines (e.g., server computers) having a variety of configurations. The distributed computing infrastructure 126 may be based on the Windows Azure™ cloud platform from Microsoft Corporation, but other cloud platforms may be used.

The validation client 102 may be configured to define a validation pipeline for execution of a set of validation jobs. One or more validation jobs may then be assigned to a respective one of the virtual machines. Each validation job may include one or more validation tasks to be implemented. For example, a validation job may include one or more test tasks to be implemented and one or more static analysis tasks. Each validation task may involve the application or execution of one or more validation tools.

By distributing the validation jobs across the virtual machines, the validation pipeline definition may establish the parallel execution of the validation jobs. The parallelization of the validation process may significantly decrease the time consumed by the validation process.

The validation jobs of a validation pipeline may have dependencies or affinities. In some cases, the results of one test may impact or otherwise relate to the implementation of another test. For example, one test may verify the setup of a software product, while subsequent tests verify the functionality of the software product. The validation pipeline definition may thus, in some cases, specify an order of execution of some or all the validation jobs in the validation pipeline. However, the validation pipelines defined by the validation client 102 need not involve a serial execution or flow of pipeline jobs.

The jobs of a validation pipeline may be allocated to a pool of virtual machines of the distributed computing infrastructure 126. The pool provides an isolation boundary for the job or jobs of the pipeline. A pool may include any number of virtual machines. The size of the pool may be scaled to match an expected load of the validation pipeline. Additional virtual machines may be added to a pool by the deployment manager 124 during implementation of the validation pipeline, if, for instance, the load presented by the validation pipeline is unexpectedly high. Virtual machines may also be removed from the pool by the deployment manager 124 if, for instance, no more work remains to be done.

The validation client 102 may utilize the communication management service 120 of the validation server 104 to assign validation jobs to the virtual machines. Each virtual machine may thus be assigned a worker role in accordance the assigned validation job. The nature of the jobs and roles may vary with the characteristics of the validation pipeline to be implemented. In the example of FIG. 1, the distributed computing infrastructure 126 includes test worker virtual machines (VMs) 130 to implement software testing tasks, analysis worker VMs 132 to implement software analysis tasks, and a summary worker VM 134 to aggregate or summarize the results of the testing and analysis tasks, any number of which may be assigned.

The validation server 104 may also include a job management service 136 to facilitate the assignment of validation jobs within the distributed computing infrastructure 126. The job management service 136 may be configured to respond to a request (e.g., from the validation client 102) for an isolated pool of virtual machines for deployment of a validation pipeline or coordinate job reassignments between virtual machines during the implementation of a validation pipeline. The number of jobs assigned to a particular virtual machine may vary during execution. The job management service 136 may be configured to support these and other communications with the deployment manager 124. For example, data exchanges between the validation server 104 and the cloud-based data store 122 and/or one or more components of the distributed computing infrastructure 126 may be handled by the job management service 136.

The validation server 104 may include one or more additional services to support data exchanges and other communications between the validation client 102 and other components of the architecture 100 during implementation of the validation process. In this example, the validation server 104 includes a reporting service 138 directed to the handling of result data generated during implementation of the validation pipeline. For example, each test worker VM 130 and each analysis worker VM 132 may be configured to summarize the results of the test or analysis. That summary data may then be aggregated by the summary worker VM 134 to generate one or more reports and/or other data sets. Alternatively or additionally, summarization may be implemented by the reporting service 138 and/or by the validation client 102. The reporting service 138 may be configured to support data transmissions of the reports and other data sets from the networked computing infrastructure 126 to the validation client 102. Such data may be transmitted via an internet connection 106 between the distributed computing infrastructure 126 and the validation server 104. In some cases, a communication link for such data transmissions may be facilitated by the deployment manager 124. For example, the deployment manager 124 may include a communication manager (e.g., a communication manager VM) to support the communications. Alternatively, the communication link need not involve the deployment manager 124 as an intermediary.

In some cases, a validation job may be assigned to more than one virtual machine. For example, a validation job may involve assigning a tester role to one or more virtual machines and a testee role to one or more other virtual machines acting as an application server 140. The code data representative of the software product being tested is installed on the application server(s) 140. The software product may be configured to provide a software service (e.g., software as a service). The validation test binary data is installed on one or more of the test worker VM(s) 130. Each such test worker VM 130 may then implement a functional test, a stress test, a penetration test, or other test against the software service provided by the application server(s) 140.

The validation client 102 may define the validation pipeline to include such validation jobs based on the configuration data. The configuration data may specify the validation tasks to be implemented, as well as the configuration or customization of such tasks and any expected results (e.g., thresholds to be met) of such tests. The configuration data may be set forth in any number of files or data sets stored in the data store 108. In the example of FIG. 1, the configuration data is set forth in a static configuration file 142 and a dynamic configuration file 144. Additional, fewer, or alternative data files may be used to set forth the configuration data. The static configuration file 142 may include data indicative of a default configuration of a standard set of validation tools to be implemented in the validation pipeline. The dynamic configuration file 144 may include data indicative of parameters used to customize the standard set of validation tools (e.g., override a default or standard configuration), and/or data indicative of non-standard validation tools to be implemented in the validation pipeline.

The static configuration file 142 and/or the dynamic configuration file 144 may also include data specifying a job order or job grouping(s) for the validation pipeline. For example, the static configuration file 142 and/or the dynamic configuration file 144 may include data indicative of dependencies or affinities of the validation tasks to determine an appropriate pipeline order. To comply with the dependencies and/or affinities, the static configuration file 142 and/or the dynamic configuration file 144 may include data specifying groupings or orders of validation tasks to be implemented serially or together in a validation job. For example, the static configuration file 142 may specify default groupings of tasks to define the jobs of the validation pipeline. The default groupings may then be overridden by data in the dynamic configuration 144 directed to splitting up the tasks differently. Overriding the default groupings may be useful in avoiding resource contention issues, including, for example, ensuring that a single virtual machine is not overburdened with too many time-consuming validation tasks.

The manner in which the data in the dynamic configuration file 144 customizes the default or standard configuration data may vary considerably. In one example, the dynamic configuration data may modify a threshold or other expected result to be achieved during a test. Other examples may specify parameters to customize or change the behavior of a test. Still other examples may involve injecting an entirely new test or analysis task into the validation pipeline. For instance, one or more test binaries may be injected or pulled into a test, an external service endpoint to validate against may be specified, and validations may be added or removed.

The dynamic configuration file 144 or other source of dynamic configuration data may be used to change the validation pipeline definition during execution of the validation pipeline. The characteristics of one or more validation jobs may be thus be modified after the initial deployment of the resources of the distributed computing infrastructure 126. For example, the dynamic configuration data may be used to reassign validation tasks between jobs of the validation pipeline. Such reassignments may be useful to address or remove possible delays that would otherwise arise from an overburdened virtual machine.

The dynamic configuration data may also be used to specify various types of metadata regarding the validation pipeline. For example, locations at which the code data or the validation tool binary data 118 can be accessed for processing by the validation client 102 may be specified. The location of the binary files may be specified by a file or folder path, and/or may be indicative of a local or remote network location.

The configuration data in the static configuration file 142 and/or the dynamic configuration file 144 may be arranged in an extensible markup language (XML) framework. Other frameworks or arrangements may be used. For example, the configuration data may alternatively or additionally be set forth in a spreadsheet, a database, or other data structure. Additional configuration data may be provided from sources other than XML or other data files. For example, configuration parameters may be specified via a command line instruction provided by a user of the validation client 102. In other cases, configuration data may be provided via computing environment variables.

FIG. 2 shows the validation client 102 in greater detail. The validation client 102 may include a number of instruction sets to implement the validation tasks of the validation pipeline via the resources of the distributed computing infrastructure 126 (FIG. 1). The instruction sets may be arranged in respective modules. The modules or other instruction sets may be stored in a memory, such as one or more of the memories described below in connection with FIG. 5. The validation client 102 may be configured by the instruction sets to act as a controller or control system of the validation process. In this example, the validation client 102 includes instructions for a pipeline definition module 150, a data packaging module 152, a pipeline management module 154, a pipeline monitoring module 156, and a report viewer 158. The instructions of each module are configured for execution by a processor of the validation client 102 to control respective aspects of the validation process. The modules may be integrated to any desired extent.

Additional, fewer, or alternative modules may be included. For example, the functionality of one or more of the modules may be provided by the validation server 104 (FIG. 1), and accessed by a user via a browser-based user interface at the validation client 102. The report viewer 158 may, for instance, be provided via a browser-based user interface or a client application. In such cases, instructions directed to implementing the functionality may nonetheless be provided to, stored in, and executed via, a browser 160 of the validation client 102. For example, the instructions may be set forth via browser-executable script files provided by the validation server 104 to the validation client 102. The same functionality may thus be provided in such cases, by instructions stored in a memory of the validation client 102, and executed by a processor of the validation client 102, despite the lack of resident, executable modules stored at the validation client 102.

The instructions of the pipeline definition module 150 may configure the validation client 102 to define a validation pipeline based on the configuration data to implement the validation tasks of the validation pipeline. The pipeline definition module 150 may be operative to access one or more of the above-referenced configuration files or other sources of configuration data. One or more of the files or other sources may provide default or standard pipeline definition data for, e.g., a set of default validation tasks. One or more of the files or other sources may specify parameters to customize a set of default validation tasks.

The pipeline definition module 150 may also be configured to generate a user interface to support the selection or other specification of configuration parameters or data. For example, the user interface may facilitate the selection of the test or analysis binaries to be run in the validation pipeline. Alternatively or additionally, a command line interface may be generated to facilitate the specification of configuration data. The user interface or other source of configuration data may also be used to specify metadata for the validation tasks or other aspects of the validation process. For example, metadata may be provided to specify the locations of the code data representative of the software product to be tested and/or analyzed, and/or of the binary data for the validation tools to be used in implementing the validation tasks of the validation pipeline. In embodiments in which the validation client 102 is integrated with the build system 110 (FIG. 1), the locations, structure, and other characteristics of the code data of the software product may already be known.

The pipeline definition module 150 may also be configured to implement an automated test selection routine. The metadata provided to the pipeline definition module 150 may be used to determine which test(s) and/or analysis(es) are warranted. For example, the metadata may specify that a location or other characteristic of the code data to be processed that indicates that a particular test case is relevant.

The pipeline definition module 150 may also be configured to define one or more summary tasks for the validation pipeline. The summary task(s) may be configured to aggregate or summarize the results of the tests and/or analyses. The configuration of the summary task(s) may thus be based on the particular tests and/or analyses to be implemented in the pipeline.

The instructions of the data packaging module 152 may configure the validation client 102 to access, receive, or otherwise obtain code data representative of the software product and to generate a plurality of data packages for the jobs of the validation pipeline. Each data package includes the code data and validation tool binary data operative to implement one or more of the validation tasks in accordance with the validation pipeline. In some embodiments, a data package is generated for each job of the validation pipeline. A respective one of the data packages may thus be provided for configuration of each virtual machine. Such configuration of each virtual machine may allow a virtual machine to be configured as a stand-alone, one-box tester (or analyzer) in which implementation of the validation task(s) of a job does not involve accessing external resources during execution. In other embodiments, a set of virtual machines may be configured with a data package to act as testers of a software service hosted by one or more “testee” virtual machines. In still other embodiments, a virtual machine may be provided with more than one data package for implementation of multiple jobs.

The validation client 102 may receive validation tool binary data operative to implement any number of software test tasks and/or software analysis tasks. The software test tasks may be configured to implement a test case or other test against the code data and/or receive software analysis tasks. The software analysis tasks may be configured to implement a static code analysis of the code data. The data packaging module 152 may be configured to aggregate the binary data for such tasks in various ways. For example, the data packaging module 152 may generate data packages directed solely to implementing test tools and data packages directed solely to implementing analysis tools. In some cases, the data packaging module 152 may generate data packages including a combination of test and analysis tools.

The data packaging module 152 may be configured to store or otherwise associate each data package with a job identification code. Each virtual machine may then be provided the job identification code to download the appropriate data package. The job identification codes may be initially created during the pipeline definition process by the pipeline definition module 150.

The instructions of the pipeline management module 154 may configure the validation client 102 to initiate execution of the validation tasks on the virtual machines of the distributed computing infrastructure 126 (FIG. 1). The pipeline management module 154 may generate a user interface (or user interface element(s) to be provided by a user interface generated by some other module) to receive a request to initiate the execution of the validation pipeline. Upon receipt of the request, the pipeline management module 154 may upload or send the data packages generated by the data packaging module 152 to the cloud-based data store 122 (FIG. 1) in preparation for configuring each virtual machine. The data packages may be sent with storage instructions to the validation server 104 (FIG. 1) or other management server configured to support data exchanges with the cloud-based data store 122 and other components of the architecture 100 (FIG. 1). Alternatively, the uploading of the data packages may occur before the receipt of the request to initiate the pipeline execution. For example, the uploading may occur in connection with the definition of the pipeline.

The request to initiate execution may instruct the validation server 104 (FIG. 1) to request a pool or other allocation of virtual machines. The pipeline management module 154 may be configured to propose a pool size or other characteristic (e.g., pool isolation) of the requested allocation in accordance with an estimate of the computing resources to be used during pipeline execution. The request may also include instructions to provide the virtual machines with the job identification codes to facilitate the downloading of the data packages from the cloud-based data store 122 (FIG. 1).

The pipeline management module 154 may also send instructions to the validation server 104 to enable reassignments and other adjustments during pipeline execution. For example, the validation server 104 may be instructed to direct the deployment manager 124 (FIG. 1) to reassign jobs during pipeline execution. Such reassignments may be triggered by the receipt (via, e.g., the pipeline monitoring module 156) of data regarding the state of one of the virtual machines or the distributed computing infrastructure 126 (FIG. 1). The reassignment instructions may thus be sent in connection with a request or message delivered during pipeline execution. Alternatively, the instructions may be sent with the request to initiate pipeline execution to enable, for instance, an automated reassignment.

The reassignment or other instructions sent by the pipeline management module 154 to the deployment manager 124 may include instructions to implement a data wiping or cleanup procedure. The deployment manager 124 may be instructed to implement a data wiping of each virtual machine upon completion of a job. The data wiping may be configured to reimage or return the virtual machine to an original state prior to configuration in accordance with the data package. Once returned to the original state, the virtual machine may be assigned one or more validation tasks previously assigned to a different virtual machine.

The data wiping may also be implemented conditionally. For example, a virtual machine may not need the data wiping if the validation tasks of the now-completed job were executed successfully, e.g., without an error or a failure. The instructions sent by the pipeline management module 154 may specify the conditions under which the data wiping is to occur.

The pipeline management module 154 may be configured to send a number of other requests, instructions, or other communications during the execution of the pipeline. Such communications may relate to directions for uploading result data to the cloud-based data store 122 (FIG. 1), or involve responses to events detected by the pipeline monitoring module 156.

The instructions of the pipeline monitoring module 156 may configure the validation client 102 to generate alerts or other messages via a user interface of the validation client 102 and/or via other media (e.g., text messages, emails, etc.). The alert may relate to a state or status of the pipeline execution, such as the execution time for a particular job exceeding a threshold. Alternatively or additionally, the pipeline monitoring module 156 may configure the validation client 102 to provide status information continually or periodically via a user interface, e.g., an interface provided via the browser 160.

Further information regarding the pipeline execution is provided by the report viewer 158. In this embodiment, the report viewer 158 generates a user interface of the validation client 102 dedicated to presenting the results of the tests and/or analyses of the pipeline. The user interface may be integrated with those provided via the browser 160 to any desired extent.

The report viewer 158 may also configure the validation client 102 to implement various data processing tasks on the result data provided from the virtual machines. Such processing may include further aggregation, including, for instance, trend analysis. The processing may be implemented upon receipt of a user request via the user interface, or be implemented automatically in accordance with the types of result data available.

The browser 160 may also be used to facilitate networked communications with the validation server 104 (FIG. 1). In some embodiments, the validation client 102 is configured as a terminal device in which case the user interfaces and other control of the validation process is provided via the browser 160. The browser 160 may enable the client-server framework of the validation client 102 and the validation server 104 to establish a computing system configured to implement one or more aspects of managing or controlling the validation process of the disclosed embodiments.

FIGS. 3 and 4 depict an exemplary method for validation of a software product. The method is computer-implemented. For example, one or more computers of the validation client 102 shown in FIG. 1 may be configured to implement the method or a portion thereof. The implementation of each act may be directed by respective computer-readable instructions executed by a processor of the validation client 102 and/or another processor or processing system. Additional, fewer, or alternative acts may be included in the method. For example, the data packages of code data and validation tool binary data need not be sent or uploaded to the cloud-based data store 122 (FIG. 1) to support delivery to the virtual machines. In alternative embodiments, for example, the data packages are transmitted via the validation server 104 (FIG. 1) directly to the distributed computing infrastructure 126 (FIG. 1) for delivery to the virtual machines. In these and other cases, peer-to-peer caching of the data packages (or components thereof) between the virtual machines (or other components of the distributed computing infrastructure 126) may be used to provide the binary and other data for implementation of the validation tasks. Such caching may be useful in other scenarios, including, for example, job reassignments.

The method may begin with one or more acts related to receipt of a request for validation of a software product. For example, a user may access a user interface generated by the validation client 102 (FIG. 1) to submit the validation request. Alternatively, the method may be initiated or triggered automatically by an event, such as completion of a build or generation of a change list.

In the embodiment of FIG. 3, the method begins with an act 200 in which code data representative of the software product to be tested and/or analyzed is accessed, received, or otherwise obtained. The code data may be stored in a resident memory or otherwise available. For example, the code data may have been generated by a build system or tool running on, or otherwise integrated or in communication with, the computer implementing the method. Obtaining the code data in such cases may involve accessing the memory in which the code data is stored.

The manner in which the code data is obtained may vary, as may the characteristics of the code data. For example, in some cases, the code data is obtained by generating or otherwise receiving build data from a build system or tool in an act 202. Alternatively or additionally, the code data may include intermediate representation (IR) data (e.g., abstract syntax tree data) or other parsed or partially compiled representation of the source code. The code data may also or alternatively be obtained by generating or receiving change list data in an act 204.

In an act 206, validation tool binary data is received, accessed, or otherwise obtained. The validation tool binary data is operative to implement a number of validation tasks, including software test tasks and/or software analysis tasks, as described above. In some cases, binary data is obtained for a number of software test tasks configured to implement test cases, e.g., unit tests or other dynamic software tests against the code data. Binary data may alternatively or additionally be obtained for a number of software analysis tasks configured to implement various static code analyses of the code data. In some cases, the validation tool binary data obtained in the act 206 is directed to implementing a standard or default set of validation tools. Binary data for additional or alternative validation tools may be obtained subsequently, such as, for example, after the receipt of configuration data calling for one or more non-standard validation tools.

The validation tool binary data may also include binary data to support the implementation of one or more summary tasks of the validation pipeline. The summary task(s) may be implemented via a tool(s) configured to aggregate, summarize, or otherwise process result data generated by the other validation tasks of the pipeline. For example, the summary task(s) may be configured to generate data for a report to be provided to a user. The report data may include diagnosis data relating to failures encountered during the validation process. The validation tool binary data may be configured to be implemented on one or more of the virtual machines.

In act an 208, configuration data for a plurality of validation tasks of the validation pipeline is received, accessed, or otherwise obtained. For example, the configuration data may be received via various types of user interfaces, including, for instance, a command line interface. The configuration data may be directed to customizing the operation of the validation tools for which binary data was previously obtained. Alternatively or additionally, the configuration data may be directed to identifying additional or alternative tools to be incorporated into the validation pipeline. The configuration data may be obtained by accessing one or more configuration data files. The configuration data may be arranged in the files in an XML framework, although other frameworks, data structures, or arrangements may be used. In the embodiment of FIG. 3, a static configuration XML file is accessed in an act 210, and a dynamic configuration XML file is accessed in an act 212. The configuration data in the static configuration XML file may be indicative of default settings or parameters for the validation tasks of the pipeline (e.g., the standard set of validation tools). The configuration data in the dynamic configuration XML file may be indicative of custom settings or parameters for the validation tasks of the pipeline, and may also or alternatively be indicative of any non-standard validation tasks to be incorporated into the pipeline.

The validation pipeline is defined based on the configuration data in an act 214. The definition of the validation pipeline is defined may include receiving a specification of the jobs of the pipeline in an act 216. For example, a user interface generated to allow a user to select or otherwise specify validation tasks to be implemented, group such tasks into jobs, and otherwise specify the jobs of the pipeline. The specification of the validation jobs may include receiving further configuration data for the validation tasks. The specification of the jobs of the pipeline may be received or obtained in other ways, including, for example, an automated procedure that organizes the validation tasks into groups based on historical data (e.g., data indicative of how long a particular task took to run). The validation pipeline may be defined via other automated procedures, including, for example, an automated test selection routine conducted in an act 218. The test selection routine may be configured to analyze the code data (e.g., change list data) to determine the task(s) that may be useful to run. Defining the validation pipeline definition may also include defining one or more summary tasks in an act 220 configured to summarize or aggregate the results of the execution of the other tasks in the pipeline. The summary task(s) may be configured for execution on one of the virtual machines.

In an act 222, data packages are generated to implement the validation pipeline across the distributed computing architecture. Each data package includes the code data and validation tool binary data operative to implement one or more of the validation tasks in accordance with the configuration data. In some cases, a respective data package is provided to each virtual machine to configure the virtual machine for one-box testing. In other cases, a data package may be provided to or distributed across multiple virtual machines. For example, such distribution may support a tester-testee arrangement, as described above. In another example, the multiple virtual machines may implement a parallel execution of simulations or other tests, analyses, or other validation tasks.

The preparation of the data packages may include several pre-processing steps. Such pre-processing may include synchronizing code data (e.g., to a user-selected version or timestamp) in an act 224. The pre-processing may alternatively or additionally include executing one or more builds, linking steps, or other code processing in an act 226 in the event that such data is not generated or obtained previously. The validation tool binary data may also be processed in preparation for the generation of the data packages. For example, the validation tool binary data may updated or modified in accordance with the configuration data (e.g., dynamic configuration data).

Upon completing the pre-processing of the code data and/or validation tool binary data, further pre-processing may be implemented to aggregate the code data and the validation tool binary test data in an act 228 to prepare the data packages for the jobs as set forth in the validation pipeline definition. In an act 230, a job identification code may be assigned to each data package to facilitate deployment of the data package to a respective one or more of the virtual machines.

Execution of the validation pipeline may be initiated in connection with the deployment or other delivery of the data packages. With the data packages, the code data and data indicative of the defined validation pipeline is sent to configure each virtual machine in accordance with the code data and the defined validation pipeline. In the embodiment of FIG. 3, initiation of the execution of the validation pipeline includes an intermediate delivery to a data store before deployment across the resources of the distributed computing infrastructure. In other embodiments, execution of the validation pipeline does not include such intermediate, pre-deployment delivery. In an act 232, the data packages are sent to a data store, such as the cloud-based data store 122 (FIG. 1). The data structures may be delivered via a management server (e.g., a communication management server), such as the validation server 104 (FIG. 1), to which a network connection may be established in an act 234. A message may be sent via the network connection to instruct the management server to deliver the data packages to the data store. The message may include further instructions regarding the manner in which the data packages are to be stored (e.g., BLOB or other data structures). The data packages may be uploaded to the management server and the data store with the job identification codes and/or any other metadata, e.g., to facilitate subsequent deployment.

One or more further instructions for execution of the validation pipeline on the virtual machines may be sent in an act 238. The further instructions may be sent individually or collectively, including, for instance, with the above-referenced instructions regarding storage of the data packages. The further instructions may be integrated to any desired extent. The further instructions may be sent to a management server, such as the job management service 136 of the validation server (FIG. 1).

In this embodiment, data indicative of the validation pipeline definition is sent to the management server in an act 240. Such data may be useful in managing the execution of the jobs, including, for instance, coordinating reassignments of validation tasks within jobs and/or entire jobs. Alternatively or additionally, an instruction is sent in an act 242 to request a pool of virtual machines or other allocation or set of virtual machines assigned to the validation pipeline. The request may include data specifying or indicative of the size or capacity of the pool, and/or other characteristics of the pool, such as, for example, the isolation of the pool. Yet another instruction may be sent in an act 244 regarding configuration of the virtual machines within the pool. For example, the instruction may relate to data wiping each of the virtual machines before downloading the data package and/or after execution of the validation task(s). Such data wiping may be useful in returning a respective virtual machine to a state prior to configuration in accordance with one of the data packages in preparation for further use in implementing other validation jobs in the pipeline. For example, the data wiping may be conditioned upon whether a failure occurred during the validation task(s) already executed on the virtual machine. Still other instructions may be sent in acts 246 and 248 to enable the management server to direct the virtual machines to establish a network connection or other communication link with the data store. The communication link may be used to download the data packages (e.g., by job identification code) from the data store and to upload result data back to the data store.

FIG. 4 depicts an exemplary execution of the validation pipeline. The progress or status of the execution is monitored in an act 250, which may include receiving status data from the management server in an act 252. The status data may be indicative of the jobs completed thus far, the jobs in progress, the presence of any failures or errors, an estimated time to completion, and/or any other data regarding the status of the pipeline execution. Further data may be received from the management in an act 254 regarding the system state of one or more of the virtual machines. For example, the system state data may be indicative of the health or operational characteristics of the virtual machines, including, for instance, memory and processor usage. Upon receipt of the status and system state data, the validation client 102 (FIG. 1) may generate a user interface to display such data in an act 256.

The monitoring of the pipeline execution may be used to periodically or otherwise check for failures. In this embodiment, the validation client 102 (or other system component) determines whether a validation job (or task thereof) completes or otherwise terminates with a failure in a decision block 258. If the validation job terminates without a failure, control may pass to another decision block 260 in which the validation client 102, the validation server, or other system component is given the opportunity to request or facilitate the adjustment of one or more job assignments across the virtual machines. Each virtual machine that successfully completes a job may be assigned one or more validation tasks previously assigned to another virtual machine. The job(s) may be re-assigned in an act 261, and progress of the pipeline execution may then continue with a return to the act 250. Further decision blocks or logic may be included in the method, including, for instance, logic to determine whether a threshold has been exceeded for job completion. The threshold may be based on historical data.

If no job reassignments are requested, or the virtual machine completes a job with a failure, then control passes to a further decision block 262 in which the validation client 102 (or other system component) determines whether the execution of the pipeline is complete. If not, then control may return to the act 250 for further monitoring. The virtual machine with the failure may be reimaged or returned to an original state via a data wiping procedure at this point for use in connection with another job. If the pipeline execution is complete, control passes to an act 264 in which summary or other result data is downloaded from the data store. The result data may include raw data generated by the validation tasks or data generated from such raw data. The result and/or summary data may have been previously uploaded to the data store during execution as part of a validation task and/or in connection with a summary task configured to aggregate or otherwise process the result data uploaded by the other validation tasks.

The downloaded result data may then be processed (e.g., by the validation client) in an act 266. For example, the result data may be aggregated with data from previous pipeline executions to generate trend data. The downloaded result data and/or the data generated therefrom may then be displayed in an act 268 via a report viewer or other user interface generated by, e.g., of the validation client.

The order of the acts of the method may vary from the example shown. For example, data may be aggregated for one or more binary data packages before the definition of the pipeline. In another example, some or all of the configuration data used to define the validation pipeline is obtained before the code data and/or the validation tool binary data.

With reference to FIG. 5, an exemplary computing environment 300 may be used to implement one or more aspects or elements of the above-described methods and/or systems. The computing environment 300 may be used by, or incorporated into, one or more elements of the architecture 100 (FIG. 1). For example, the computing environment 300 may be used to implement the validation client 102, the validation server 104, the deployment manager 124, and/or any of the resources of the distributed computing infrastructure 126. The computing environment 300 may be used or included as a client, network server, application server, or database management system or other data store manager, of any of the aforementioned elements or system components. The computing environment 300 may be used to implement one or more of the acts described in connection with FIGS. 3 and 4.

The computing environment 300 includes a general-purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The units, components, and other hardware of computer 310 may vary from the example shown.

Computer 310 typically includes a variety of computer readable storage media configured to store instructions and other data. Such computer readable storage media may be any available media that may be accessed by computer 310 and includes both volatile and nonvolatile media, removable and non-removable media. Such computer readable storage media may include computer storage media as distinguished from communication media. Computer storage media may include both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 310.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 5 illustrates operating system 334, application programs 335, other program modules 336, and program data 337. For example, one or more of the application programs 335 may be directed to implementing one or more modules or other components of the validation client 102, the validation server 104, the deployment manager 124, and/or any instruction sets of the systems and methods described above. In this or another example, any one or more the instruction sets in the above-described memories or data storage devices may be stored as program data 337.

Any one or more of the operating system 334, the application programs 335, the other program modules 336, and the program data 337 may be stored on, and implemented via, a system on a chip (SOC). Any of the above-described modules may be implemented via one or more SOC devices. The extent to which the above-described modules are integrated in a SOC or other device may vary.

The computer 310 may also include other removable/non-removable, volatile/nonvolatile computer storage media. By way of example only, FIG. 5 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 5, provide storage of computer readable instructions, data structures, program modules and other data for the computer 310. For example, hard disk drive 341 is illustrated as storing operating system 344, application programs 345, other program modules 346, and program data 347. These components may either be the same as or different from operating system 334, application programs 335, other program modules 336, and program data 337. Operating system 344, application programs 345, other program modules 346, and program data 347 are given different numbers here to illustrate that, at a minimum, they are different copies. In some cases, a user may enter commands and information into the computer 310 through input devices such as a keyboard 362 and pointing device 361, commonly referred to as a mouse, trackball or touch pad. Other input devices (not shown) may include a microphone (e.g., for voice control), touchscreen (e.g., for touch-based gestures and other movements), ranger sensor or other camera (e.g., for gestures and other movements), joystick, game pad, satellite dish, and scanner. These and other input devices are often connected to the processing unit 320 through a user input interface 360 that is coupled to the system bus, but may be connected by other interface and bus structures, such as a parallel port, game port or a universal serial bus (USB). In some cases, a monitor 391 or other type of display device is also connected to the system bus 321 via an interface, such as a video interface 390. In addition to the monitor, computers may also include other peripheral output devices such as printer 396 and speakers 397, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 5. The logical connections include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. FIG. 5 illustrates remote application programs 385 as residing on memory device 381. The network connections shown are exemplary and other means of establishing a communications link between the computers may be used.

The computing environment 300 of FIG. 5 is only one example of a suitable computing environment and is not intended to suggest any limitation as to the scope of use or functionality of the technology herein. Neither should the computing environment 300 be interpreted as having any dependency or requirement relating to any one or combination of components illustrated in the exemplary operating environment 300.

The technology described herein is operational with numerous other general purpose or special purpose computing system environments or configurations. Examples of well-known computing systems, environments, and/or configurations that may be suitable for use with the technology herein include, but are not limited to, personal computers, server computers (including server-client architectures), hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A computer-implemented method for validation of a software product via a distributed computing infrastructure, the computer-implemented method comprising:
obtaining configuration data for a plurality of validation tasks of the validation;
obtaining code data representative of the software product;
defining a validation pipeline to implement the plurality of validation tasks based on the configuration data; and
initiating execution of the plurality of validation tasks on a plurality of virtual machines of the distributed computing infrastructure, wherein initiating the execution comprises sending the code data and data indicative of the defined validation pipeline to configure each virtual machine in accordance with the code data and the defined validation pipeline.

2. The computer-implemented method of claim 1, further comprising generating a plurality of data packages to implement the validation pipeline, each data package comprising the code data and validation tool binary data operative to implement a number of the plurality of validation tasks in accordance with the configuration data.

3. The computer-implemented method of claim 2, wherein sending the code data and the data indicative of the defined validation pipeline comprises sending instructions to a management server to store the plurality of data packages in a networked data store in communication with the plurality of virtual machines.

4. The computer-implemented method of claim 3, further comprising assigning a job identification code to each data package to facilitate deployment of the data package to a respective one of the plurality of virtual machines.

5. The computer-implemented method of claim 1, further comprising receiving validation tool binary data operative to implement a software test task of the plurality of validation tasks, wherein the software test task is configured to implement a test case against the code data.

6. The computer-implemented method of claim 1, further comprising receiving validation tool binary data operative to implement a software analysis task of the plurality of validation tasks, wherein the software analysis task is configured to implement a static code analysis of the code data.

7. The computer-implemented method of claim 1, wherein receiving the configuration data comprises accessing a configuration file in which data indicative of a set of default validation tasks is specified.

8. The computer-implemented method of claim 1, wherein receiving the configuration data comprises accessing a configuration file in which parameters are specified to customize a set of default validation tasks.

9. The computer-implemented method of claim 8, wherein the configuration data is arranged in the configuration file in an extensible markup language (XML) framework.

10. The computer-implemented method of claim 1, wherein the validation pipeline comprises a summary task configured for execution on one of the plurality of virtual machines to summarize results of the execution of the plurality of validation tasks.

11. A system for validation of a software product, the system comprising:
a data store in which configuration data for a plurality of validation tasks of the validation is stored;
a memory in which pipeline definition instructions, data packaging instructions, and pipeline management instructions are stored; and
a processor coupled to the memory and the data store, and configured to execute the pipeline definition instructions to define a validation pipeline based on the configuration data to implement the plurality of validation tasks;
wherein the processor is further configured to execute the data packaging instructions to obtain code data representative of the software product and to generate a plurality of data packages, each data package comprising the code data and validation tool binary data operative to implement a number of the plurality of validation tasks in accordance with the validation pipeline; and
wherein the processor is further configured to execute the pipeline management instructions to:
initiate execution of the plurality of validation tasks on a plurality of virtual machines of the distributed computing infrastructure; and
send the plurality of data packages to configure each virtual machine in accordance with a respective one of the plurality of data packages.

12. The system of claim 11, wherein the pipeline management instructions are configured to cause the processor to send the plurality of data packages to a management server configured to manage communications with the distributed computing infrastructure.

13. The system of claim 12, wherein:
the management server is configured to communicate with the distributed computing infrastructure to direct a data wiping of a respective virtual machine upon completion of the execution of the number of validation tasks for the data package executed by the respective virtual machine; and
the data wiping is configured to reimage the respective virtual machine to a state prior to configuration in accordance with the respective data package.

14. The system of claim 11, wherein the pipeline management instructions are configured to cause the processor to send instructions to a management server to store the plurality of data packages in a networked data store in communication with the plurality of virtual machines.

15. The system of claim 11, wherein the pipeline definition instructions are configured to cause the processor to access a configuration file in which data indicative of a set of default validation tasks is specified.

16. The system of claim 11, wherein the pipeline definition instructions are configured to cause the processor to access a configuration file in which parameters are specified to customize a set of default validation tasks.

17. The system of claim 11, wherein:
the data packaging instructions are configured to cause the processor to receive the validation tool binary data;
the validation tool binary data comprises binary data operative to implement a software analysis task of the plurality of validation tasks; and
the software analysis task is configured to implement a static code analysis of the code data.

18. The system of claim 11, wherein the pipeline management instructions configure the processor to request an assignment of an isolated pool of virtual machines comprising the plurality of virtual machines.

19. A computer program product for validation of a software product, the computer program product comprising one or more computer-readable storage media having stored thereon computer-executable instructions that, when executed by one or more processors of a computing system, cause the computing system to perform the method, the method comprising:
receiving configuration data for a plurality of validation tasks of the validation;
receiving code data representative of the software product;
defining a validation pipeline to implement the plurality of validation tasks based on the configuration data;
generating a plurality of data packages to implement the validation pipeline, each data package comprising the code data and validation tool binary data operative to implement a number of the plurality of validation tasks in accordance with the configuration data; and
initiating execution of the plurality of validation tasks on a plurality of virtual machines of the distributed computing infrastructure, wherein initiating the execution comprises sending instructions to a management server to store the plurality of data packages in a networked data store in communication with the plurality of virtual machines to configure each virtual machine in accordance with a respective one of the plurality of data packages.

20. The computer program product of claim 19, wherein:
the management server is configured to direct a data wiping of a respective virtual machine upon completion of the execution of the number of validation tasks for the data package that configured the respective virtual machine; and
the data wiping is configured to return the respective virtual machine to a state prior to configuration in accordance with the respective binary package.
